(19) United States
(12) Patent Application Publication
(10) Pub. No.: US 2016/0292899 A1
(43) Pub. Date: Oct. 6, 2016

(54) NUMERICAL CONTROLLER WITH HIGH-VISIBILITY PROGRAM DISPLAY FUNCTION

(71) Applicant: FANUC Corporation, Minamitsuru-gun (JP)

(72) Inventor: Koji SATO, Minamitsuru-gun (JP)

(21) Appl. No.: 15/083,328

(22) Filed: Mar. 29, 2016

(30) Foreign Application Priority Data
Mar. 30, 2015 (JP) 2015-068973

(51) Int. Cl. G06T 11/60

(52) U.S. Cl. CPC G06T 11/60

(57) ABSTRACT

A numerical controller parses a machining program in consideration of an option configuration and parameter setting, and changes and displays display attributes based on the meaning of a word acquired as a result of the parsing for control, thereby improving the visibility of the entire machining program.

### BACKGROUND OF THE INVENTION

1. Field of the Invention

The present invention relates to a numerical controller with a high-visibility program display function.

2. Description of the Related Art

In displaying an NC program on its display, a numerical controller parses the NC program in consideration of visibility for operators and then displays significant words (address-plus-number) in a spaced manner (e.g., Japanese Patent Application Laid-Open No. 07-271418).

For example, Japanese Patent Application Laid-Open No. 06-168020 discloses another conventional technique based on the consideration of visibility for operators of a numerical controller. According to this technique, display attributes are set and displayed in different colors in columns for display items on a display unit.

An NC program used for the control of a machine by a numerical controller comprises a number of words each consisting of an address and a number. In this program, even such words as a rapid traverse command G00 and a feed rate F100 that have greatly different meanings for control are described by similar expressions. Thus, there is a problem that the spindle speed, feed rate, and the like cannot be distinguished at a glance even in the case where they are expected to be positively noted in order to change cutting conditions, for example.

Even if a conventional NC program display method, such as that disclosed in Japanese Patent Application Laid-Open No. 07-271418, is used, the meanings of words in the NC program for control cannot be ascertained at a glance, though the difference between the words can easily be perceived. Thus, the above-described problem cannot be solved by this method.

Further, the technique disclosed in Japanese Patent Application Laid-Open No. 06-168020 is not intended to improve the visibility of information in the NC program, though it ensures distinction between the displayed columns. Thus, the above-described problem cannot be solved by this technique either.

### SUMMARY OF THE INVENTION

Accordingly, the object of the present invention is to provide a numerical controller configured so that a change target can be easily found on a program edit screen for an NC program.

A numerical controller according to the present invention is configured to display a machining program and comprises: a character attribute setting area configured to store the meaning and display attribute of a word used in the machining program in association with each other; a range attribute setting area configured to store an operation mode and the display attribute in association with each other; a setting information storage area configured to store setting information on the numerical controller; a display attribute change character determination unit configured to refer to the character display attribute setting area and the setting information storage area and determine to change the display attribute of the word included in the machining program; a display attribute change range determination unit configured to refer to the range attribute setting area and the setting information storage area and determine to change the display attribute of strings in a range in which an operation is performed in a specific operation mode included in the machining program; a display attribute changing unit configured to change the display attribute of a character or a string included in the machining program, based on the respective determinations of the display attribute change character determination unit and the display attribute change range determination unit; and a display unit configured to display the machining program the display attribute of which is changed by the display attribute changing unit.

According to the present invention, an operator can easily find a change target on a program edit screen, so that the program editing efficiency is improved.

### BRIEF DESCRIPTION OF THE DRAWINGS

The above and other objects and features of the present invention will be obvious from the ensuing description of embodiments with reference to the accompanying drawings, in which:

FIG. 1 is a diagram showing an example in which display attributes of characters or strings in a machining program are changed by a program display function of a numerical controller according to the present invention;

FIG. 2 is a diagram showing an example in which display attributes of strings in a specific operation mode range in the machining program are changed by the program display function of the numerical controller according to the present invention;

FIG. 3 is a functional block diagram of one embodiment of the numerical controller according to the present invention;

FIG. 4A is a diagram showing a character display attribute setting table in the numerical controller shown in FIG. 3; and

FIG. 4B is a diagram showing a range display attribute setting table in the numerical controller shown in FIG. 3.

### DETAILED DESCRIPTION OF THE PREFERRED EMBODIMENTS

According to the present invention, a program is parsed in consideration of an option configuration and parameter setting, and display attributes are changed and displayed based on the meaning of a word acquired as a result of the parsing for control. In this way, the visibility of the entire NC program can be improved.

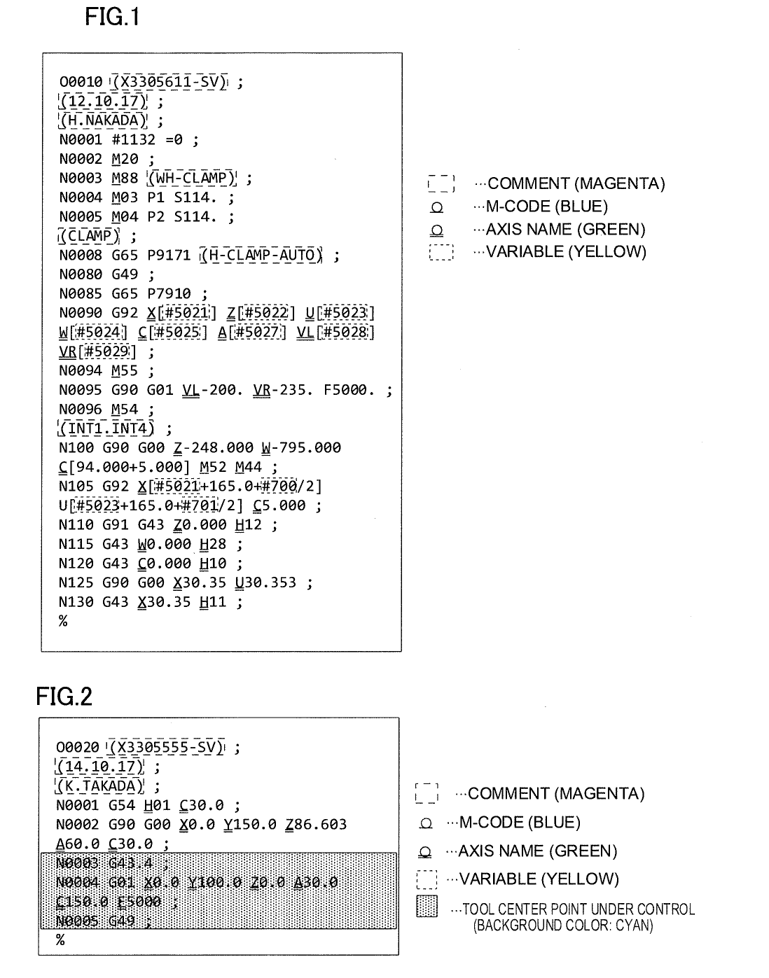

In the present invention, as shown in FIG. 1, there are provided

(1) means for changing a color expression based on differences in meaning of axis names, M-codes (M), comments, and the like for each word, as shown in FIG. 1, and

(2) means for expressing, in different colors, program ranges for different operation modes, such as a range in the NC program for tool center point control and a range for cutting feed/rapid traverse.

In connection with FIGS. 1 and 2, the display attributes of strings are described by framing and underlining the strings. Actually, however, display attributes such as the colors of framed and underlined strings and their backgrounds are changed and displayed.

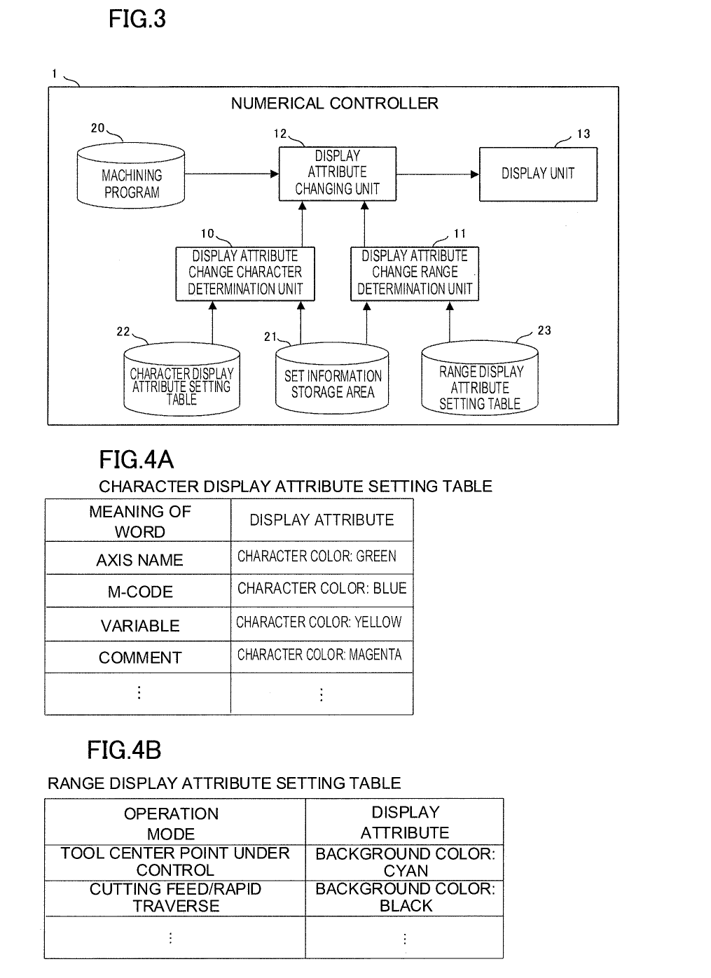

FIG. 3 is a functional block diagram of a numerical controller according to one embodiment of the present invention.

A numerical controller 1 comprises a display attribute change character determination unit 10, display attribute change range determination unit 11, display attribute changing unit 12, and display unit 13.

The display attribute change character determination unit 10 refers to a character display attribute setting table 22 for setting display attributes such as character colors for the meanings of words used in the machining program. Also, the determination unit 10 reads the option configuration, parameter setting, and the like set in the numerical controller 1 from a setting information storage area 21, and determines the display attributes to be set for the words included in the machining program.

In the character display attribute setting table 22, as shown in FIG. 4A, the display attributes are specified in association with “meanings of words”. The “meanings of words” described here include:

direct expressions by specific characters or strings such as an M-code (M), variable (#), and rapid traverse command (G00);

expressions of word groups such as feed commands (G00, G01) and correction commands (G41, G42, etc.) that imply identical control concepts; and

changes of expressions such as axis names in the machining program by settings (option configuration, parameter setting, etc.) in the numerical controller 1.

The display attribute change character determination unit 10 sequentially reads the character display attribute setting table 22,

creates commands for changing the display attributes of characters or strings corresponding to the meanings of read words, if any, directly expressed by the characters or strings in the machining program,

creates commands for changing the display attributes of characters or strings belonging to separately defined word groups if the meanings of words representative of word groups that imply identical control concepts are read,

reads the option configuration and the parameter setting in the setting information storage area 21 and creates a string to be changed, based on the content of read setting, if the setting related to the meaning of the word the expression of which in the machining program is changed by the setting in the numerical controller 1 is read, and

creates a command to change the created string to the specified display attributes.

An axis name is an example of a word for which the expression in the machining program is changed by the setting in the numerical controller 1. If an extended axis name is enabled by setting, the axis name is created by synthesizing parameters Nos. 1020, 1025 and 1026. If the extended axis name is disabled, the axis name is created based on the parameter No. 1020. It is necessary, moreover, to use an additional parameter such as a subscript parameter No. 3131 or create a target string based on the option or machine configuration (M-system/T-system, etc.), depending on the specifications of the controller. The display attribute change character determination unit 10 creates a string of a word as a display attribute change target so as to meet the setting in the numerical controller 1, based on an algorithm created according to the specifications of the numerical controller 1.

With respect to strings in a range in which an operation is performed in a specific operation mode in the machining program, the display attribute change range determination unit 11 refers to a range display attribute setting table 23 for setting display attributes such as background colors. Also, the determination unit 11 reads the option configuration, parameter setting, and the like set in the numerical controller 1 from the setting information storage area 21, and determines the display attributes of the strings in the range in which an operation is performed in a specific operation mode in the machining program.

In the range display attribute setting table 23, as shown in FIG. 4B, the display attributes are specified in association with operation modes. For example, tool center point control (range surrounded by blocks individually including words G43.4 and G49) may be given as a typical operation mode.

The display attribute change range determination unit 11 sequentially reads the range display attribute setting table 23 and creates commands for change to the display attributes of strings in a range in which an operation is performed in a specified operation mode, based on the definition of a separately set range of a read operation mode.

The display attribute changing unit 12 reads the machining program stored in a machining program storage area 20 and parses the machining program. Based on commands from the display attribute change character determination unit 10 and the display attribute change range determination unit 11, the changing unit 12 changes the display attributes of the strings included in the machining program. In changing the display attributes, prefix search is performed for words obtained by parsing so that the display attributes of all the matched strings are changed.

Further, the display unit 13 receives the machining program with its display attributes changed by the display attribute changing unit 12 and displays it for operators' information.

In this way, the numerical controller of the present embodiment changes and displays the display attributes of the characters or strings that constitute the machining program, based on the display attributes set in the character display attribute setting table 22 and the range display attribute setting table 23, in displaying the machining program. Thus, an operator can ascertain the entire configuration of the machining program at a glance and hence can easily find a word to be changed, so that the program editing efficiency is improved.

While an embodiment of the present invention has been described herein, the invention is not limited to the above-described embodiment and may be suitably modified and embodied in various forms.

For example, the numerical controller may be provided with setting means by which the operator can set the character display attribute setting table 22 and the range display attribute setting table 23. If this is done, the operator can set the display attributes so that he/she can easily find the noticeable word depending on the situation, thereby performing the program editing more efficiently.

Although the character and background colors are given as the typical display attributes in the example described above, moreover, various other display attributes, such as blinking, highlighting, and enhancement, may be suitably used instead.

1. A numerical controller which displays a machining program, comprising:
a character attribute setting area configured to store the meaning and display attribute of a word used in the machining program in association with each other;
a range attribute setting area configured to store an operation mode and the display attribute in association with each other;
a setting information storage area configured to store setting information on the numerical controller;
a display attribute change character determination unit configured to refer to the character display attribute setting area and the setting information storage area and determine to change the display attribute of the word included in the machining program;
a display attribute change range determination unit configured to refer to the range attribute setting area and the setting information storage area and determine to change the display attribute of strings in a range in which an operation is performed in a specific operation mode included in the machining program;
a display attribute changing unit configured to change the display attribute of a character or a string included in the machining program, based on the respective determinations of the display attribute change character determination unit and the display attribute change range determination unit; and
a display unit configured to display the machining program the display attribute of which is changed by the display attribute changing unit.
